(19) United States
(12) Patent Application Publication
(10) Pub. No.: US 2022/0065188 A1
(43) Pub. Date: Mar. 3, 2022

(54) INTERNAL COMBUSTION ENGINE INCLUDING AN ELEMENT AT THE CYLINDER INNER WALL FOR SCRAPING OFF OIL CARBON

(71) Applicant: DEUTZ Aktiengesellschaft, Koeln (DE)

(72) Inventors: Martin BLANKENHORN, Blaubeuren (DE); Thomas BREHMER, Hennef (DE); Stephan HEEGER, Koeln (DE); Thomas HOEN, Roesrath (DE); Peter HOFFMANN, Koeln (DE); Ulf KLEIN, Much (DE); Thomas WERNER, Koeln (DE)

(21) Appl. No.: 17/406,100

(22) Filed: Aug. 19, 2021

(30) Foreign Application Priority Data
Sep. 3, 2020 (DE) 10 2020 005 386.6

(51) Int. Cl. F02F 1/00; F02B 77/04

(52) U.S. Cl. CPC F02F 1/004; F02F 2001/006; F02B 77/04

(57) ABSTRACT

An internal combustion engine of a motor vehicle includes an element at the cylinder inner wall for scraping off oil carbon. The internal combustion engine includes at least one working cylinder and a cylinder head closing the working cylinder, the working cylinder including a cylinder barrel and/or a cylinder liner (1), and which includes at least one element in the area of the cylinder head, which is suitable for scraping off any accumulated oil carbon.

This claims the benefit of German Patent Application DE 10 2020 005 386.6, filed Sep. 3, 2020 which is hereby incorporated by reference herein.

The present disclosure relates to an internal combustion engine including an element at the cylinder inner wall for scraping off oil carbon.

### BACKGROUND

An annular insert is known from DE 35 43 668 A1, which projects from the head side of the cylinder liner. It narrows the inner diameter of the cylinder or the cylinder liner and prevents oil carbon from coming into contact with the cylinder inner wall.

DE 103 21 034 B3 shows an annular design, which reduces the diameter as an insert in a groove or as an insert which projects over the cylinder liner on the head side and is inserted without clearance between the liner and the cylinder head. This is not suitable for large series, since the clearance-free insert imposes greater demands on manufacturing and assembly.

A design is described in DE 10 2011 012 507 B4, which projects above the cylinder liner as an insert, into which a groove is inserted. The insert narrows the area of the top dead center position, due to rotationally symmetrical and asymmetrical outer and inner contours of the ring element.

### SUMMARY

It is an object of the present disclosure to avoid the aforementioned disadvantages and to provide an internal combustion engine, which consumes little oil, generates little oil carbon, without disadvantages which must be accepted in terms of component stiffness.

An internal combustion engine of the aforementioned type is provided including at least one element at the cylinder inner wall, which is worked into the cylinder inner wall by machining or an embossing/pressing method in the corresponding TDC area of the fire land of the piston and carries out the approximate function of a fire ring.

Knurled sections or straight knurls, to some extent also diamond knurls, are circumferential shape deviations manufactured by knurling, which are embossed into a metallic rotational body at the inner or outer surface. Knurled sections may make a workpiece more non-slip and thus prevent sliding, for example on a dumbbell grip. The knurled section may take on different shapes and be introduced either by milling, pressing or by embossing on a lathe.

Straight knurling and diamond knurling are two related manufacturing methods from the group of embossing, which is a form of pressure forming. In both methods, a round workpiece is pressed against a round tool and rolled, so that they both rotate. The profile of the tool is transferred to the workpiece. The raised areas of the tool are pressed into the surface of the workpiece. Depending on whether the straight knurls or diamond knurls (left-right knurl, cross-knurling) occur, one speaks of straight knurling or diamond knurling.

For example, grips or grip surfaces of micrometers are often knurled to make them more non-slip than smooth surfaces.

Knurling for embossing decorative elements or writing onto the edge of a coin or medal formerly made it more difficult to file or cut the coins, because a filing point is immediately visible.

A further application is the generation of a serrated profile for a shaft-hub connection, e.g. for fastening a rotor assembly on a shaft to transfer higher torques than in the case of a shrink joint or a knurled screw.

In knurling, a distinction is made between non-cutting knurling and machine-cut knurling. Depending on the method, the profile is pressed in with the aid of knurling wheels or machined using a knurling cutter. Special knurling cutting tools may also be used on CNC lathes including driven tools to avoid shifting to other machines. Since the machining forces during cutting are lower, it is used primarily for thin workpieces or on machining centers.

Knurls exist in the following versions: RAA: knurl with axially parallel grooves; RBL: left-hand knurl; RBR: right-hand knurl; RGE: left-right knurl, points raised, also referred to as fish skin; RGV: left-right knurl, points indented; RKE: cross knurls, points raised; RKV: cross knurls, points indented; RTR: circular knurling (continuous). The profile angle is 90°, also 105° in special cases. The knurled section is situated in the cylinder head-side end area of the inner wall at the height of the top dead center position of the corresponding piston fire land.

Pistons for reciprocating engines are usually manufactured from cast aluminum alloys, in certain cases also from cast iron. The blanks are die-cast. Due to performance increases and to reduce consumption and emissions with the aid of higher ignition pressures, the pistons for powerful turbo diesel engines are also forged. The lateral surface, the valve pockets, the piston ring grooves and the piston pin bore are mechanically processed.

Technological differences exist between diesel and gasoline engine pistons, due to the different combustion processes.

Diesel pistons are subjected to higher thermal as well as mechanical loads and must therefore be reinforced in the first piston ring groove with the aid of a cast-in ring carrier made of an austenitic cast iron (Ni-resist) to prevent a knocking out of the groove and transfer of material to the ring by microscopic bonding. In the case of highly stressed pistons, brass bushings are pass-fitted in the pin bore. Another characteristic feature of the pistons of diesel engines with direct injection is the crown trough, in which the injected fuel is swirled and mixed with air. Pistons under high thermal load, in particular racing, aircraft or turbo diesel engines, are often implemented with injection nozzles for the engine oil for cooling the piston crown. The piston may be provided with a circumferential oil channel or be cooled only by a spraying of the crown. In slow-running large engines, the piston may also be cooled by recirculation cooling. The medium is supplied to the piston through a telescopable tube.

In pistons of gasoline engines, the wall thickness is thinner than in pistons of diesel engines, which permit higher engine rotational speeds, due to their lower weight. In the area of the first piston ring groove, a hard anodizing may be used to some extent to avoid wear and microscopic bonding.

The piston crown may to some extent carry shallow pockets for accommodating the valves projecting into the combustion chamber.

The piston includes the following functional components: the piston crown, which is in contact with the medium. The piston crown is also referred to as the fire land top edge. The fire land comes next. It extends from the piston crown to the upper piston ring groove. It protects the first piston ring from overheating. It abuts the ring belt. Together with the further grooves and ring lands, the fire land forms the so-called ring belt. This is followed by the piston skirt or the piston shaft or the piston wall, the cylindrical component which fits into the cylinder bore with little clearance, and the piston pin including its bearing, which connects the piston to the connecting rod.

The piston skirt is used to guide the piston within the cylinder liner and, in most pistons, is coated with a lubricant varnish. In older designs, it often carries a cast-in steel strip on the inside (control piston, “control plate,” “autothermic piston”) to control the diameter increase during heating. To reduce weight, in many fast-running four-stroke engines, the piston skirt today is recessed inwardly (“box-type” piston) on the sides (at the piston pin openings).

The piston carries one or multiple grooves for the piston rings, the topmost of which are the compression rings, and at least one lower one being used as an oil scraper piston ring. Passenger car pistons overwhelmingly have two compression rings and one oil scraper piston ring. For racing engines, so-called dual-ring pistons including only one compression ring may also be used. In two-stroke engines, the piston skirts may also be provided with windows. In addition, most two-stroke pistons have safety pins in the piston ring grooves to prevent the piston ring joints from rotating and becoming stuck in the control windows of the cylinder. In the past, there were two-stroke engines including baffled pistons, which were intended to improve the gas exchange during cross scavenging. For approximately the past 90 years, two-stroke engines with reverse scavenging have had a flat piston crown.

The knurled section described above scrapes the resulting oil carbon and other combustion residue from the fire land surfaces of the piston, so that they are unable to damage the honing during a downward motion of the piston in the direction of the bottom dead center (BDC), thus reducing wear. A number of design criteria exist, for example piston tilting gradient, fire land clearance, fire land zone, etc., which define the minimum height of the knurled section. This design height (throw-up height) is generally smaller in aluminum pistons than in steel pistons. The higher raised areas result in particular demands on the manufacturing method, since the materials used tend to be unsuitable for the throw-up. Safety distances must also be maintained, e.g., knurled section up to the first piston ring. The knurled section is an integral ring element of a cylinder or a cylinder liner, which faces the piston in the TDC or its fire land at the height of the top dead center position of the corresponding piston at the inner wall of the cylinder or a cylinder liner. Due to inclined grooves throwing up at an angle with respect to the cylinder axis or the axis of the cylinder liner, which narrow the dead center position between the fire land zone and the first piston ring, the clearance is greatly reduced by the smaller inner diameter between the straight knurled section and the fire land surface.

The cylinder liner, which is manually pushed and clamped onto a vice, receives a clearance and an inner chamfer in a first step. Due to the knurling wheel (special ground section) during the embossing method, the head-side knurled section facing the inner wall and situated in the area of the top dead center position of the corresponding piston fire land is created, as described above. The smallest inner diameter is then turned. The clearance takes on an important role in the manufacturing process. The embossing into the cylinder liner results in the transport of material; if there is no clearance, the sealing surface of the cylinder or the cylinder liner may possibly become uneven.

The knurled section is worked into the inner wall of the cylinder or the cylinder liner by machining or a pressing or embossing method at the height of the top dead center position of the corresponding piston. According to the present disclosure, it is provided for the long-term and reliable removal of the accumulating oil carbon and other combustion residue. The grooves of the knurled section are raised and thus narrow the area and scrape the oil carbon from the piston outer contour in the area between the piston crown and the first piston ring and counteract wear or the degradation of the honing. A deposit is possible only in a very thin, fine layer. With regard to manufacturing, the knurled section due to straight knurling—the knurling method described above—may be used for mass production.

According to one preferred embodiment of the present disclosure, the formation of the grooves of the knurled section in the cylinder liner or the cylinder is situated at an angle to the cylinder axis or axis of the cylinder liner.

The knurled section of the cylinder liner or the cylinder removes accumulating oil carbon and other conceivable residues from the fire land of the piston. The knurled section of the cylinder liner or the cylinder does not end at the first piston ring but maintains a minimum safety distance to avoid damage to the piston ring. The raised knurled section of the cylinder liner or the cylinder on the inside has a narrowing effect and reduces the clearance in the area of the fire land surface. Less room thus exists for accumulating oil carbon, since the inner diameter in the area of the knurled section is smaller due to the raised grooves.

### BRIEF DESCRIPTION OF THE DRAWINGS

The present disclosure is explained in greater detail below on the basis of one exemplary embodiment.

FIG. 1 shows a detail of an internal combustion engine, which shows the knurled section of a cylinder liner and an associated piston;

FIG. 2 shows a detail of the knurled section, which shows the grooves.

### DETAILED DESCRIPTION

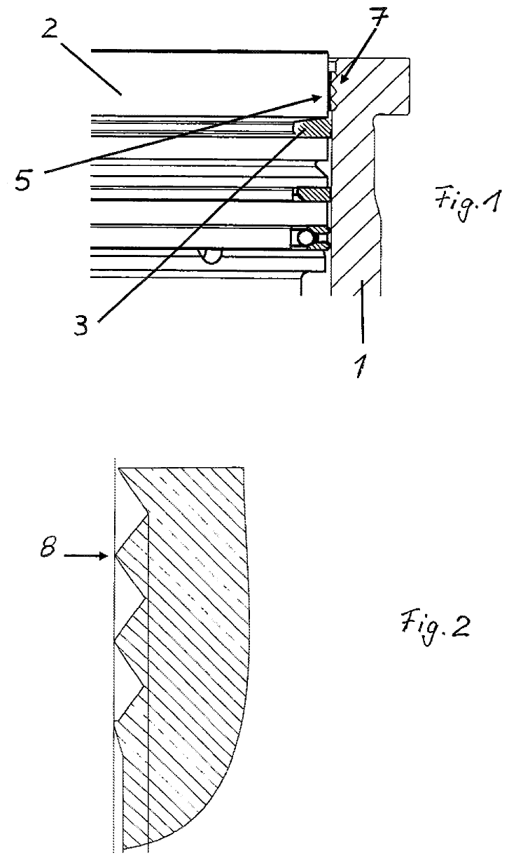

FIG. 1 shows a detail of an internal combustion engine, including a cylinder liner 1, embossed knurled section 7 in the area of the cylinder head-side top dead center position of corresponding piston 2 at its inner wall. Piston 2 includes piston rings 3, a piston crown and fire land zone 5, which extends from the piston crown to first piston ring 3. The narrowing of cylinder liner 1 in the area of the top dead center position of the corresponding piston begins with knurled section 7, as is apparent in detail in FIG. 2. Due to the raised knurled sections, which cylinder liner 1 has on its inner wall, the inner diameter in this area (TDC) is smaller than in the remaining course of the cylinder or cylinder liner 1. As a result, no oil carbon or only oil carbon in a very small quantity or in a very thin layer may accumulate in fire land zone 5, which increases wear and may damage the cylinder liner and the honing in the upward and downward motion of piston 2. Grooves 8 and knurled sections 7 are situated in an inclined manner and have an angle with respect to the cylinder or cylinder liner 1. Knurled section 7 is an integral part of the cylinder or cylinder liner 1 and may be machined out of the preferred material of the cylinder or cylinder liner 1. Methods of non-cutting knurling are also useful to apply knurled section 7 in the cylinder or the cylinder liner.

FIG. 2 shows an enlarged view of knurled section 7 in the axially parallel section; individual grooves 8 are apparent as integral parts of the cylinder or cylinder liner 1.

### LIST OF REFERENCE NUMERALS

1 cylinder liner
2 piston
3 piston ring
5 fire land zone
7 knurled section
8 groove

What is claimed is:

1. An internal combustion engine comprising:
at least one working cylinder; and
a cylinder head closing the working cylinder, the working cylinder including a cylinder barrel or a cylinder liner including at least one element in an area of the cylinder head or a top dead center of a corresponding piston of the cylinder barrel or cylinder liner, the at least one element being configured for scraping off any accumulated oil carbon.

2. The internal combustion engine as recited in claim 1, wherein the at least one element is raised in a direction of the corresponding piston.

3. The internal combustion engine as recited in claim 1, wherein the at least one element includes at least one circumferential groove.

4. The internal combustion engine as recited in claim 1, wherein the at least one element includes at least one knurled section.

5. The internal combustion engine as recited in claim 3, wherein the at least one knurled sections is raised at an inner wall of the cylinder barrel or the cylinder liner.

6. The internal combustion engine as recited in claim 1, wherein an inner diameter of the cylinder barrel or the cylinder liner is smaller in the area of the cylinder head or the top dead center of a corresponding piston than in an remaining course of the cylinder barrel or the cylinder liner due to the at least one element.

7. The internal combustion engine as recited in claim 1, wherein the at least one element is made up of at least one circular circumferential groove.

8. The internal combustion engine as recited in claim 1, wherein the at least one element is made up of circumferential grooves situated one above the other in a circular manner.

9. The internal combustion engine as recited in as recited in claim 1, wherein the at least one element is made up of an inner thread.

10. The internal combustion engine as recited in claim 1 wherein the internal combustion engine is a diesel engine of a motor vehicle.

11. A method for operating an internal combustion engine comprising:
providing the internal combustion engine as recited in claim 1; and
operating the internal combustion engine such that the at least one element scrapes off any accumulated oil carbon.
